(19) United States
(12) Patent Application Publication
(10) Pub. No.: US 2023/0213236 A1
(43) Pub. Date: Jul. 6, 2023

(54) Ventilation Fan with Replaceable Panel

(71) Applicant: Homewerks Worldwide, LLC., Lake Bluff, IL (US)

(72) Inventors: Peter BERKMAN, Highland Park, IL (US); Michael MALAKER, Kenosha, WI (US); Huang XIAOYING, Guangdong (CN); Lin TIAOHAO, Foshan (CN); He LITING, Foshan (CN)

(21) Appl. No.: 18/093,230

(22) Filed: Jan. 4, 2023

Related U.S. Application Data
(60) Provisional application No. 63/296,385, filed on Jan. 4, 2022.

(51) Int. Cl. F24F 13/08; F24F 7/007

(52) U.S. Cl. CPC F24F 13/084; F24F 7/007; F24F 2221/14; F24F 2221/32; F16B 2001/0035

(57) ABSTRACT

A ventilation fan unit for causing air flow with respect to a room having a ceiling, the room designed for occupancy by a person. The fan unit has a fan unit housing mounted in the ceiling and having an air vent on a room facing surface of the fan unit housing for drawing air from or delivering air to the room. A replaceable panel is provided with a first surface and a second surface, the replaceable panel is removably attachable with the room facing surface of the fan unit housing by way of coupling between the replaceable panel and the fan unit housing so that the replaceable panel can be removed and replaced with another replaceable panel attachable to the fan unit housing by way of the coupling. The replaceable panel, when attached to the fan unit housing, is positioned to obstruct the person's view of the air vent while allowing flow of air therethrough

### CROSS-REFERENCE TO RELATED APPLICATION

This application claims benefit under 35 U.S.C. 119(e) of U.S. Provisional Patent application No. 63/296,385, filed Jan. 4, 2022, the entirety of which is hereby incorporated by reference herein.

### BACKGROUND OF THE INVENTION

### 1. Field of the Invention

The present disclosure is directed to the field of ventilation fans and, more particularly, to ventilation fans mounted in a ceiling for use, for example, in residential bathrooms.

### 2. Related Art

Ventilation fans for commercial and residential applications are used for controlling environmental conditions in connection with a space for occupancy by a person. These often include a fan unit positioned in a housing that is mounted in a ceiling of a room to draw air from the room (e.g. a bathroom, etc.) through air vents. A fixed panel is typically positioned over the fan unit in the bathroom to cover the fan unit and conceal the air vents to provide a more aesthetically appealing appearance to the ceiling. Considerations for such fans include ease of installation, quiet operation, multi-mode and multi-function operation, such as by incorporating lights and/or speakers, and providing a variety of fan speeds, as well as aesthetic appearance. In particular, it is desirable for such ventilation fans to be aesthetically pleasing as they can enhance the décor of the bathroom.

However, traditional ventilation fans cannot fulfill the above considerations. For example, a problem exists with known ventilation fans in that once installed, the appearance cannot be easily modified. Therefore, to change the appearance, the ventilation fan has to be uninstalled from a ceiling joist through which it is typically mounted, and replaced with another fan unit having a different appearance. This is a drawback, particularly if a bathroom is remodeled or repainted. Additionally, traditional ventilation fans are usually difficult to be installed, and many of the existing fans have numerous parts which add extra manufacturing costs. As a result, if a user desires to change the appearance, a traditional ventilation fan that requires assembly at a job site will incur undesirable extra labor and material costs to install.

Accordingly, a need exists for a ventilation fan having an easily modifiable appearance.

### SUMMARY OF THE INVENTION

A primary objective of the present invention is to provide a ventilation fan apparatus and method with a replaceable panel/cover that is easy to remove for replacement per user's preferences.

In accordance with an aspect of the invention, a ventilation fan unit is disclosed for causing air flow with respect to a room having a ceiling, the room designed for occupancy by a person. The unit comprises a fan unit housing mounted in the ceiling and having an air vent on a room facing surface of the fan unit housing for drawing air from or delivering air to the room. The unit further comprises a replaceable panel with a first surface and a second surface, the replaceable panel being removably attachable with the room facing surface of the fan unit housing by way of magnetic coupling between the replaceable panel and the fan unit housing so that the replaceable panel, when so-attached, can be removed and replaced with another replaceable panel attachable to the fan unit housing by way of magnetic coupling. The replaceable panel when attached to the fan unit housing, is positioned to obstruct the person's view of the air vent while allowing flow of air therethrough.

In some embodiments, the ventilation fan unit further includes one or more magnetic contacts on the room facing surface of the fan unit housing and the first surface of the replaceable panel for removing and replacing the replaceable panel. In some embodiments, the fan unit housing and the replaceable panel are in squared configurations, and the one or more magnetic contacts are arranged at each corner of the room facing surface of the fan unit housing and the first surface of the replaceable panel respectively. In such embodiments, the one or more magnetic contacts are in post/column configurations, and when the one or more magnetic contacts are engaged, a spacing between the room facing surface of the fan unit housing and the first surface of the replaceable panel is configured to allow ventilation to occur through the plurality of air vents and for reaching up and grasping with a user's fingers positioned in the spacing for removal and/or replacement of the replaceable panel.

In some embodiments, the ventilation fan unit further includes a light at the center of the room facing surface of the fan unit housing, and the panel has a single centrally-located opening dimensioned for receiving/accommodating the light.

In another embodiment a ventilation fan unit is disclosed for causing air flow with respect to a room having a ceiling, the room designed for occupancy by a person. The unit comprises a fan unit housing mounted in the ceiling and having a plurality of air vents on a room facing surface of the fan unit housing for drawing air from or delivering air to the room. The fan unit housing is configured to be mounted to a ceiling with its room facing surface parallel to the ceiling. A replaceable panel with a first surface and a second surface is provided. The replaceable panel is removably attachable with the room facing surface of the fan unit housing by way of attachment means positioned between the replaceable panel and the fan unit housing so that the replaceable panel, when attached to the room facing surface of the fan unit housing, can be removed and replaced with another replaceable panel attachable to the fan unit housing by way of the attachment means. The replaceable panel when attached to the fan unit housing, being positioned to obstruct the person's view of the air vent while allowing flow of air therethrough.

In one embodiment, the attachment means can be magnets. In another embodiment, the attachment means can be engaging male and female members which secure to each other in a friction fit or snap fit arrangement.

Other objects and features of the present invention will become apparent from the following detailed description considered in conjunction with the accompanying drawings. It is to be understood, however, that the drawings are designed solely for purposes of illustration and not as a definition of the limits of the invention, which is defined by the claims appended hereto. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a perspective view of a ventilation fan unit installed in a ceiling;

FIG. 2 is a side view of the ventilation fan unit of FIG. 1;

FIG. 3 is a perspective view showing removal of a panel of the ventilation fan unit; and

FIG. 4 is a perspective view showing replacing the panel of the ventilation fan unit.

### DETAILED DESCRIPTION OF THE PRESENTLY PREFERRED EMBODIMENTS

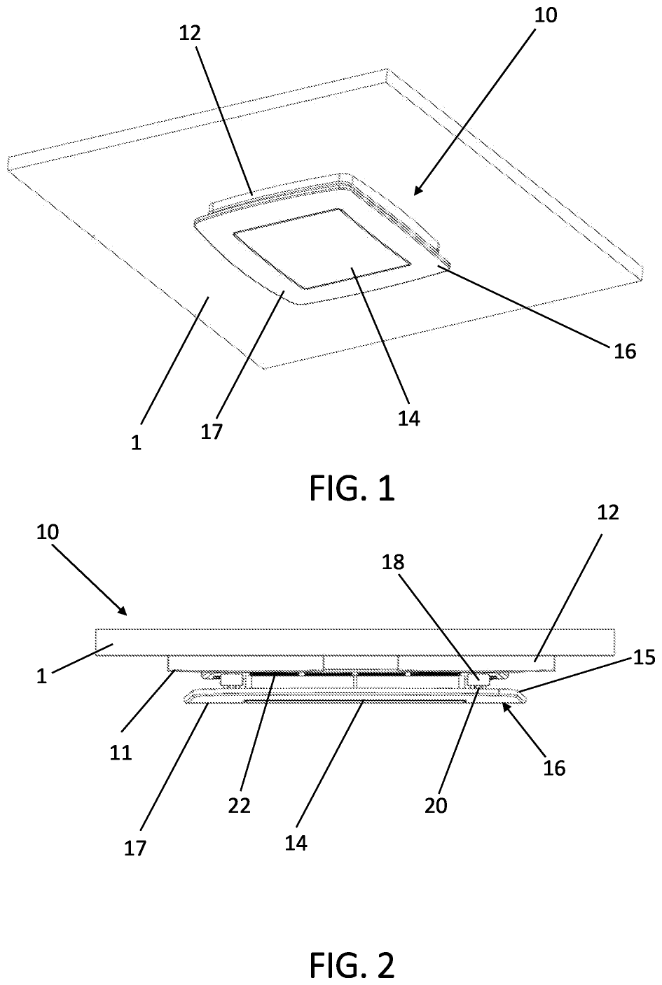

FIGS. 1-4 show a ventilation fan unit with a replaceable panel. It will be recognized that in the figures, the panel to be replaced will be in a square/rectangular shape. However the invention is not limited to such an embodiment and, for example, the panel to be replaced may be in other shapes such as in a circular disk configuration. More particularly, if the ventilation fan unit is a combination of a ventilation fan with a light feature, the panel may be configured as a frame to surround the light feature. Thus, if the light feature is a square-shaped centrally located light display including, for example, an LED array covered by a square-shaped transparent or translucent light filter, lens or diffuser (all generally referred to as a “light cover”), then the panel will be configured as a square-shaped hoop having a central area in which the light cover is positioned. Likewise, a circular or oval light cover will employ a circular or oval panel hoop, and so on.

As will be discussed in detail below, the ventilation fan of the present invention permits a user to remove and replace the ventilation fan panel in an easy way. Such a feature will improve the aesthetic value of the ventilation fan installed in the ceiling with various colors, designs, and textures, and also provide a simple solution for installation.

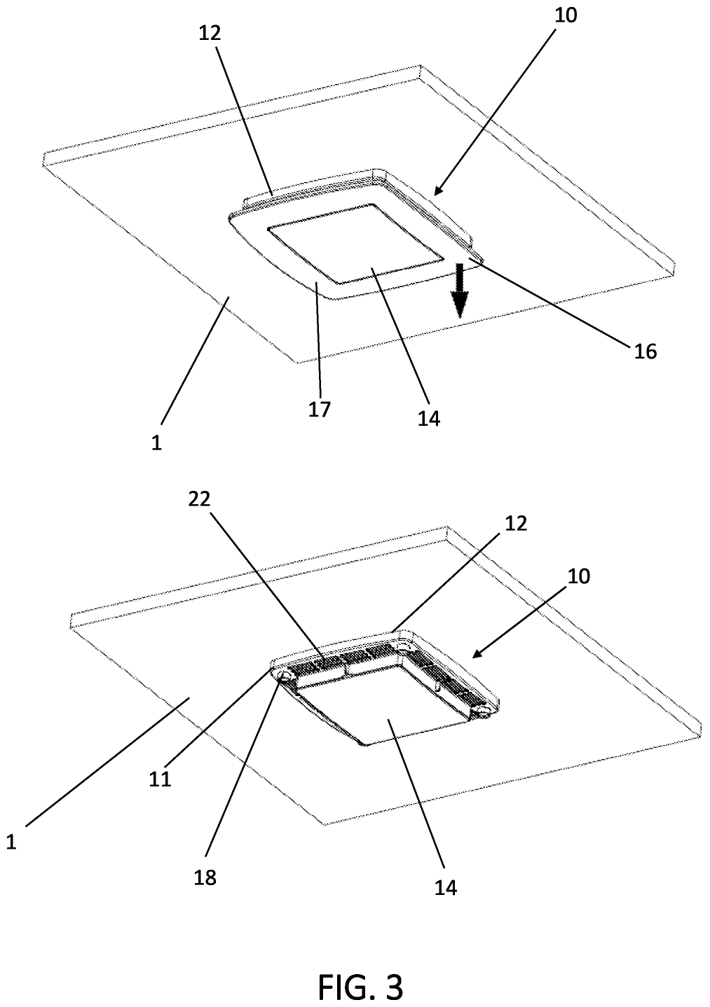

FIGS. 1 and 2 illustrate a ventilation fan unit 10 in accordance with embodiments of the invention showing a fan unit housing 12 positioned in a ceiling of a room, e.g., a bathroom and, particularly, in a suspended ceiling 1, such as drywall, sheet rock or a ceiling tile. A replaceable and decorative panel 16 is attached to a room facing surface 11 of the fan unit housing 12 parallel to the ceiling 1, such that a second surface 17 of the panel 16 is visible to a user. The ventilation fan unit housing 12 also has one or more air vents 22 on its room facing surface 11 through which air from the room is drawn or through which air to the room is delivered. In some embodiments, the panel 16 is fastened to the fan unit housing 12 using a magnetic coupling or any other feasible quick affixing/releasing mechanisms such as mating male and female fiction fit components, as discussed in detail below. The ventilation fan unit 10 may include an inverted axial fan, or any type of fan that serves the purpose of distributing/exhausting air in a relatively quiet fashion. In such a manner, the air may be drawn from the indoor environment, through the air vent(s) 22 propelled by the ventilation fan unit 10.

In different embodiments, the ceiling 1 can be formed of ceiling tiles which have any desired shape and dimension. In one or more embodiments, the overall length and width of the ceiling tiles of the ceiling 1 are approximately 2 feet, which is a standard length and width for ceiling tiles in the United States. In some embodiments, the ceiling 1 may be a drywall structure. In other embodiments, the ceiling 1 is an acoustic panel. Although the invention described here is for a generally square-shaped ventilation fan unit 10, other shapes can be easily realized by those of ordinary skill in the art, such as rectangular, circular or oval, and so on. It should be noted that any suitable designs for the ventilation fan unit 10 for suspending in the ceiling 1 can be used, such as a partially closed-in box or the like, as long as its shapes and dimensions allow the ventilation fan unit 10 to operate appropriately.

In some embodiments, the fan unit housing 12 may be made from rigid materials, such as hard plastic or stainless steel, to provide sufficient rigidity to maintain an overall shape for support. In some embodiments, the fan unit housing 12 can also include more user friendly features. For example, the fan unit housing 12 may be easy to assemble and disassemble by the user.

As shown in FIGS. 2-4, the replaceable panel 16 may include a first, upper surface 15 and a second, bottom or room facing surface 17, and is configured to fully or partially mask from an occupant of the room or environment the plurality of air vents 22 on the room facing surface 11 of the fan unit housing 12. In some embodiments, the replaceable panel 16 may be generally in a peripheral flange configuration extending outwardly from the fan unit housing 12, in parallel relationship with both the ceiling 1 and the room facing surface 11 of the fan unit housing 12. In some embodiments, the replaceable panel 16 may be square-shaped to accommodate the square-shaped fan unit housing 12. In other embodiments, the replaceable panel 16 may be circular , but it should be understood that the replaceable panel 16 can be in any suitable shapes as will be appreciated by those of ordinary skill in the art.

In some embodiments, the replaceable panel 16 may be formed of metal such as stainless steel, which has the desirable properties of high strength and rigidity. For example, the panel 16 may be formed through sheet metal stamping. In some other embodiments, however, the replaceable panel 16 can alternatively be made from suitable plastic, metal, or composite material or materials. The replaceable panel 16 may have a variety of textured finishes and/or colors and may blend with, enhance, complement or contrast, existing ceilings or walls to match the décor of the room. In particular, different replacement panels may be provided, each with a particular design, texture, color and so on, to allow a user to change the décor of the ventilation fan unit in an easy manner.

In some embodiments, a light (e.g., LED light) having a light cover 14 may be provided at the center of the room facing surface 11 of the fan unit housing 12. The replaceable panel 16 includes a single centrally-located opening dimensioned for receiving/accommodating the light cover 14, while still providing a cover for the plurality of air vents 22. Although a LED light is preferred, it should be understood that other types of lights may also be utilized in the invention and benefit from the features of the invention. For example, the light can contain at least one incandescent light bulb for emitting light through the light cover 14. It should also be understood that the light and/or light cover 14 is not necessary to the invention.

In some embodiments, the light cover 14 may incorporate the use of different colors to affect the indoor environment in which the ventilation fan unit 10 may be implemented. The different color combinations may be incorporated into the present invention in numerous ways. For example, in some embodiments, the colors blue, red, yellow, or green may be configured to generate/emit light in the blue, red, yellow, or green spectrums. Alternatively, the cover 14 may be colored to comprise the colors blue, red, yellow, or green, as the cover operates to transmit light into the room.

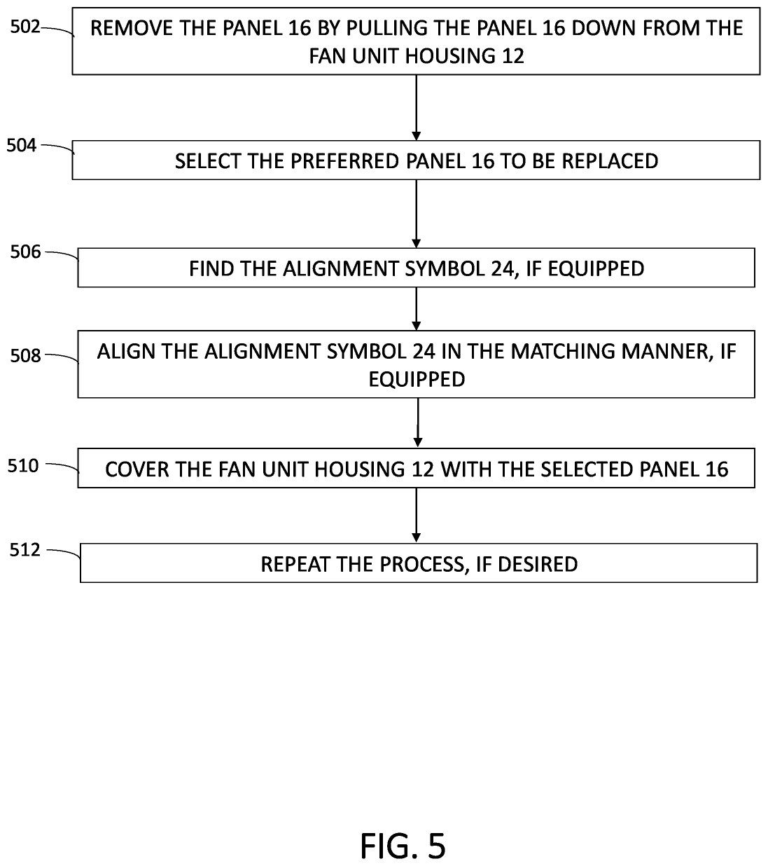

In some embodiments, mechanisms for quick affixing/releasing the replaceable panel 16 to the fan unit housing 12 may be defined by one or more magnetic tapes/strips/fasteners/contacts 18 and 20 arranged on the room facing surface 11 of the fan unit housing 12 and/or the first surface 15 of the replaceable panel 16, respectively, as best illustrated in FIGS. 2 and 4. In some embodiments, the fan unit housing 12 and the replaceable panel 16 are in square configuration, and the one or more magnetic contacts 18 and 20 are arranged at each corner of the room facing surface 11 of the fan unit housing 12 and the first surface 15 of the replaceable panel 16, respectively. It should be understood that this arrangement at each corner as shown is just an example of one possible arrangement. The magnetic contacts 18 and 20 can be arranged in any appropriate manner that provides a secure attachment of the replaceable panel 16 to the fan unit housing 12. Alternatively, the contacts 18, 20 can be complementary male and female components that engage each other in a press fit/friction fit or snap fit arrangement.

It should be understood that the magnetic attachment mechanism provides the ability to remove/replace the panel 16 from the ventilation fan unit housing 12 in a relatively easy fashion. It should also be understood that a feasible quick affixing/releasing mechanism for the panel 16 and the fan unit housing 12 should further serve to provide enough spaces between the air vent(s) 22 on the room facing surface 11 of the fan unit housing 12 and the first surface 15 of the replaceable panel 16 for an airflow passageway to allow the air to flow through the air vent(s) 22 in an unobstructed manner for adequate/proper fan performance. It should also be understood that the distributions of the one or more magnetic contacts 18 and 20 can be interrelated and can be useful, for example, to promote desired magnetic interactions, to suppress undesired magnetic interactions, and/or for other purposes. While not specifically shown, it will be understood that a variety of alternative magnetic constructions may be employed within the scope of the present invention. For example, there may be more magnetic contacts for increased magnetic holding force. In some embodiments, the magnetic attaching mechanism may be a combination of hook and loop material strips and magnetic strips or rubber strips having magnetic particles embedded therein.

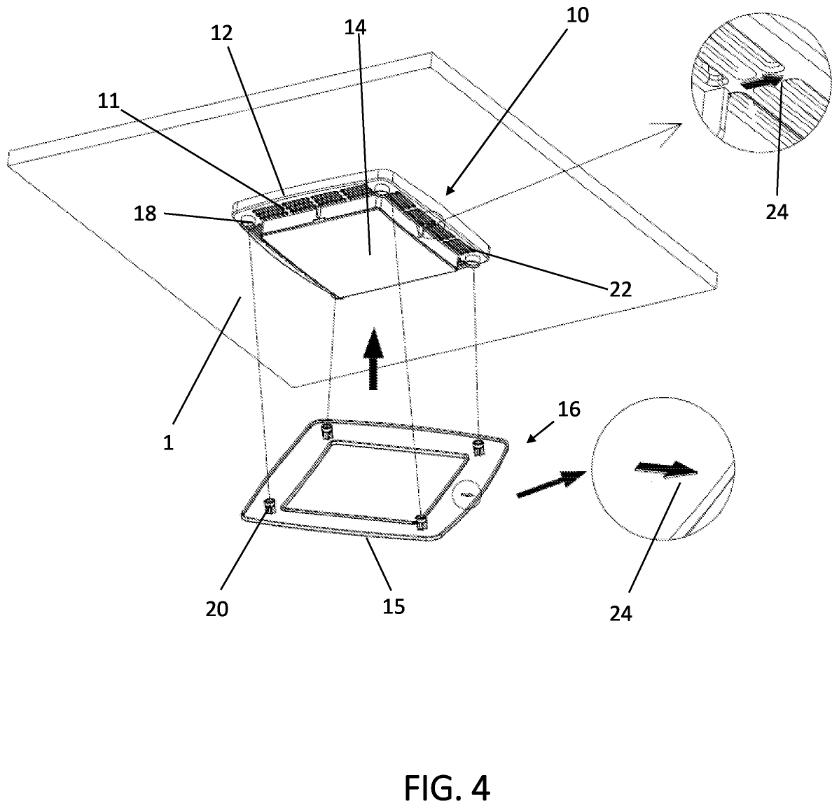

FIGS. 3 and 4 illustrate the ventilation fan unit 10 and the removal/replacement process with the replaceable panel 16. As illustrated here, the magnetic contacts 18 and 20 may be in post/column configurations and located at each corner of a square-shaped hoop panel as described above. In such embodiment, each of the respective posts 18 and 20 includes a magnet engagement, such that magnets on one or more of the posts 20 on the first surface 15 of the replaceable panel 16 engage with magnetically attractable material, such as magnets or metal, on one or more of the posts 18 on the room facing surface 11 of the fan unit housing 12. This engagement holds the panel 16 in place while also maintaining a spacing between the room facing surface 11 of the fan unit housing 12 and the first surface 15 of the replaceable panel 16 (a “ventilation gap”) to facilitate ventilation through the air vents 22. In such a manner, a user may also easily place the panel 16 on the fan unit housing 12 without undue effort.

Explaining further, it is a simple matter for a user to grasp the replaceable panel 16, hold it in a generally parallel position to the room facing surface 11 of the fan unit housing 12, and place it over with the magnetic contacts 18 and 20 engaging and magnetically attaching the replaceable panel 16 to the fan unit housing 12. In some embodiments as best shown in FIG. 4, one or more alignment marks/symbols 24 may be provided to facilitate the installation. In such embodiments, the user just needs to align the arrows in the matching manner during installation. In some embodiments, both the room facing surface 11 of the fan unit housing 12 and first surface 15 of the replaceable panel 16 may have the alignment symbols 24 to facilitate the alignment of the replaceable panel 16 in a right position relative to the fan unit housing 12. For example, in some embodiments as shown here, a plurality of alignment symbols 24, such as arrows, may be provided at one or more of the edges of both the room facing surface 11 of the fan unit housing 12 and the first surface 15 of the replaceable panel 16 to align with each other during installation. It should be understood that the mark patterns and mark positions may vary.

It should be also understood that if the coupling of the panel is by way of magnetic contacts 18 and 20, they have to provide sufficient magnetic force to prevent the panel 16 from being dislodged from the fan unit housing 12. Thus, the relationship between the weight of the panel 16 and the adhering force of the magnetic contacts 18 and 20 must be such that the panel 16 will be held firmly in place. For example, the magnetic strength for the magnetic coupling is such that the panel 16 will remain attached to the fan unit housing 12 through normal use of the ventilation fan unit 10. In other words, the panel 16 will remain attached despite vibration of the ventilation fan unit 10 while ventilation occurs, and to withstand other vibrations applied to the ceiling 1, such as from walking on a floor above the ceiling in which the ventilation fan unit 10 is mounted. In addition, the magnetic strength must also be weak enough such that the replaceable panel 16 can be easily detached from the fan unit housing 12 without causing excessive force on the ventilation fan unit 10 during detachment of the replaceable panel 16.

In a preferred embodiment, the magnet strength is in the range of N35 to N52 such that the magnetic contacts 18 and 20 hold the panel 16 in place with sufficient strength while also allowing for an easy detachment. It should be understood that the quantity and/or arrangement of the one or more magnetic contacts 18 and 20 may be modified within the scope of the invention with the concept of the panel 16 being firmly affixed to the fan unit housing 12 via the magnetic mechanism such that easy replacement may be accomplished. For example, the downward force needed to remove the panel 16 from the fan unit housing 12 may be minimal or moderate, thereby avoiding an adverse effect on the ventilation fan unit 10 mounted in the ceiling 1. Moreover, in the preferred embodiments, no hardware or special tooling is required to disengage an existing panel 16 from the ventilation fan unit 10. Rather, removal/replacement can be accomplished simply by hand as explained above.

In the embodiment shown in the figures, a total of eight magnetic contacts 18 and 20 are used for a square/rectangular configuration, namely, four (one in each corner) of the room facing surface 11 of the fan unit housing 12, and another four (one in each corner) of the first surface 15 of the replaceable panel 16. It should be understood that the first surface 15 of the panel 16 to be replaced may contain a similar arrangement of the one or more magnetic contacts 20 to engage with the one or more magnetic contacts 18 on the room facing surface 11 of the fan unit housing 12 when a currently-in-place panel 16 is removed.

In other embodiments, some other affixing/releasing mechanisms, besides the magnetic mechanism as described above, for securing the cover plate/panel 16 to the fan unit housing 12 well known in the art (not shown here) may include, but not limited to, metal binder clips, fabric hook and loop fasteners (such as Velcro®) strips, 3M Dual Lock® tapes, heavy-duty re-closable fastening tapes, threaded fasteners, adhesives, etc. It should be understood that the affixing/releasing mechanisms can be any combinations of above.

In the disclosed embodiments, the second surface 17 of the replaceable panel 16, i.e., the user-facing side of the panel 16, may have one or more of coloring, surface treatment, texture, and/or other types of design embellishments, to provide a visually appealing look to the ventilation fan unit 10. Most notably, the visual appearance of the ventilation fan unit 10 can be easily changed by a user by simply reaching up and grasping with a user's fingers positioned in the ventilation gap and applying a gentle downward force to disengage the affixing/releasing mechanism (e.g., the magnetic mechanism), thereby removing the panel 16. Once removed, a different panel 16 having a different appearances can be positioned in its place. This allows a panel 16 having a different color, texture, and/or styles to be exchanged for the now-removed panel 16 in a relative easy manner.

The embodiments of the present invention disclosed herein are intended to be illustrative only and are not intended to limit the scope of the invention. It should be understood by those skilled in the art that various modifications and adaptations of the present invention as well as alternative embodiments of the present invention may be contemplated. It is to be understood that the present invention is not limited to the sole embodiments described above, but encompasses any and all embodiments within the scope of the following claims.

What is claimed is:

1. A ventilation fan unit for causing air flow with respect to a room having a ceiling, the room designed for occupancy by a person; comprising:
a fan unit housing mounted in the ceiling and having an air vent on a room facing surface of the fan unit housing for drawing air from or delivering air to the room; and
a replaceable panel with a first surface and a second surface, the replaceable panel being removably attachable with the room facing surface of the fan unit housing by way of magnetic coupling between the replaceable panel and the fan unit housing so that the replaceable panel, when so-attached, can be removed and replaced with another replaceable panel attachable to the fan unit housing by way of magnetic coupling, the replaceable panel, when attached to the fan unit housing, being positioned to obstruct the person's view of the air vent while allowing flow of air therethrough.

2. The ventilation fan unit of claim 1, wherein the air vent comprises a plurality of air vents.

3. The ventilation fan unit of claim 1, wherein the magnetic coupling comprises magnetic contacts on one of the first surface of the replaceable panel and on the room facing surface of the fan unit housing.

4. The ventilation fan unit of claim 1 wherein the fan unit comprises a lighting element and a light cover and wherein the replaceable panel has an opening for receiving the light cover.

5. The ventilation fan unit of claim 4, wherein the magnetic coupling comprises magnetic contacts arranged along the replaceable panel and the room facing surface of the fan unit housing

6. The ventilation fan unit of claim 5, wherein the replaceable panel is in a square configuration with a central opening and wherein the magnetic contacts are disposed in corners of the square configuration replaceable panel.

7. The ventilation fan unit of claim 1, further comprising one or more alignment symbols for better alignment of the replaceable panel to the fan unit housing.

8. The ventilation fan unit of claim 7, wherein the one or more alignment symbols are arranged on both the room facing surface of the fan unit housing and the first surface of the replaceable panel.

9. The ventilation fan unit of claim 1, wherein the replaceable panel is configured as a circular disk.

10. The ventilation fan unit of claim 1, wherein the another replaceable panel has a second surface in one or more of a different color, texture, or material as compared to the second surface of the replaceable panel.

11. A ventilation fan unit for causing air flow with respect to a room having a ceiling, the room designed for occupancy by a person, comprising:
a fan unit housing mounted in the ceiling and having an with a plurality of air vents on a its room facing surface of the fan unit housing for drawing air from or delivering air to the room, the fan unit housing configured to be mounted to a ceiling with its room facing surface parallel to the ceiling; and
a replaceable panel with a first surface and a second surface, the replaceable panel being removably attachable with the room facing surface of the fan unit housing by way of attachment means positioned between the replaceable panel and the fan unit housing so that the replaceable panel, when attached to the room facing surface of the fan unit housing, can be removed and replaced with another replaceable panel attachable to the fan unit housing by way of the attachment means, the replaceable panel, when attached to the fan unit housing, being positioned to obstruct the person's view of the air vent while allowing flow of air therethrough.

12. The ventilation fan unit of claim 11, wherein the attachment means comprises one or more magnetic contacts located on offset posts to provide a spacing between the vent of the fan unit housing and the replaceable panel such that air flow from the vent is unrestricted when the removable panel is attached to the fan unit housing.

13. The ventilation fan unit of claim 11, further comprising one or more alignment symbols to facilitate alignment of the replaceable panel with the fan unit housing.

14. The ventilation fan unit of claim 11, wherein the attachment means comprises female and male mating components.

15. The ventilation fan unit of claim 14, wherein the female and male components engage each other in a friction fit manner.
